(19) United States
(12) Patent Application Publication
(10) Pub. No.: US 2018/0169809 A1
(43) Pub. Date: Jun. 21, 2018

(54) DEVICE USED FOR CENTERING EQUIPMENT HAVING CENTER HOLE

(71) Applicant: Hao GU, Beijing (CN)

(72) Inventor: Hao GU, Beijing (CN)

(21) Appl. No.: 15/127,812

(22) PCT Filed: Aug. 1, 2016
(86) PCT No.: PCT/CN2016/092662

§ 371 Date: Sep. 21, 2016

(51) Int. Cl. B23Q 3/18; B23Q 3/06; B23Q 3/10

(52) U.S. Cl. CPC B23Q 3/183; B23Q 1/0072; B23Q 3/10; B23Q 3/06

(57) ABSTRACT

Embodiments of the invention provide a device used for centering equipment having a center hole. The device includes a base; a central spindle partly coupled to the base; an upper supporting assembly partly coupled to the central spindle; and a centering device configured to act on the equipment having the center hole to perform centering operation. Using the centering device of the present disclosure to detect the deformation of equipment having a central hole, no fixtures are involved, thus saving the time for disassembling the equipment, and no need to select the fixtures to match the equipment, only to place the equipment in an appropriate way to complete the centering, thus improving the efficiency. In addition, no fixtures need preparing, which greatly reduces the costs.

### BACKGROUND OF THE INVENTION

The invention relates to equipment having a center hole, and more particularly to equipment for detecting the deformation of a hub.

### FIELD OF THE INVENTION

Typically, the deformation of equipment having a center hole, for example, a hub, is detected using special fixtures. The hub is fixed on a detection device, vertical to the ground. Manually rotate the hub and observe the horizontal or vertical movement of the edge of the hub to determine the deformation. Specifically, the deformation detection of the hub using the detection device includes the following steps. Open the fixture, and put the hub on a base; screw up the hub using the fixture having appropriate diameter; rotate the hub for detection; change another hub, repeat the above steps. In the method, the deformation detection device of the hub is a fixed device, and the movement thereof is inconvenient. The detection of each hub needs to dismount and screw up the fixture, and hubs having different diameters require corresponding fixtures. Or, directly put the hub on a rotary table, and rotate the hub for detection. However, due to the noninvolvement of the fixture, the hub cannot be centered, in the rotation process, only axial deformation of the hub can be detected, because the direction vertical to the axial direction is not centered, the deformation in the direction cannot be detected. Thus, it is urgent to upgrade the deformation detection solution of hubs.

### SUMMARY OF THE INVENTION

In view of the above-described problems, it is one objective of the invention to provide a device used for centering equipment having a center hole, the device comprising: a base; a central spindle, being partly coupled to the base; an upper supporting assembly, being partly coupled to the central spindle; and a centering device, being configured to act on the equipment having the center hole to perform centering operation.

Preferably, the equipment having the center hole includes a hub.

Preferably, the upper supporting assembly comprises a support structure which contacts and supports the equipment having the center hole, and the equipment having the center hole is axially vertical to a contact surface of the support structure.

Preferably, the centering device comprises a centering head, the centering head is disposed on the central spindle or on the upper supporting assembly; the centering head adapts to a shape and diameter of the center hole and operates to center the equipment having the center hole when the equipment having the center hole is being pressed downwards.

Preferably, the centering head comprises an elastic component capable of elastic contraction in the process of pressing downwards the equipment having the center hole.

Preferably, the elastic component is a structure adapted to elastic contraction along an axial direction.

Preferably, the structure adapted to elastic contraction along the axial direction includes a spring.

Preferably, the elastic component is a structure adapted to elastic contraction inwards along a radial direction.

Preferably, the shape of the centering head is a taper, arc, top-removed taper, and top-removed arc.

Preferably, the cone comprises a cone or pyramid, the arc comprises a circular arc, and the circular arc is bending inwards or bending outwards.

The invention also provides a centering head adapting to a shape and diameter of a center hole of equipment and operating to act on the center hole to center the equipment having the center hole when the equipment having the center hole is being pressed downwards.

Preferably, the equipment having the center hole includes a hub.

Preferably, the centering head comprises an elastic component capable of elastic contraction in the process of pressing downwards the equipment having the center hole.

Preferably, the elastic component is a structure adapted to elastic contraction along an axial direction.

Preferably, the structure adapted to elastic contraction along the axial direction includes a spring.

Preferably, the elastic component is a structure adapted to elastic contraction inwards along a radial direction.

Preferably, the shape of the centering head is a taper, arc, top-removed taper, and top-removed arc.

Preferably, the cone comprises a cone or pyramid, the arc comprises a circular arc, and the circular arc is bending inwards or bending outwards.

The invention further provides a centering device, comprising the centering head mentioned above.

Preferably, the centering device further comprises a support.

Using the centering device of the present disclosure to detect the deformation of equipment having a central hole, no fixtures are involved, thus saving the time for disassembling the equipment, and no need to select the fixtures to match the equipment, only to place the equipment in an appropriate way to complete the centering, thus improving the efficiency. In addition, no fixtures need preparing, which greatly reduces the costs.

### BRIEF DESCRIPTION OF THE DRAWINGS

FIG. 1 is a stereogram of a device used for centering equipment having a center hole of the invention;

FIG. 2 is a lateral sectional view of a device used for centering equipment having a center hole of the invention;

FIG. 3 is an exploded view of a device used for centering equipment having a center hole of the invention; and

FIG. 4 is a schematic diagram of a centering device of the invention.

### DETAILED DESCRIPTION OF THE EMBODIMENTS

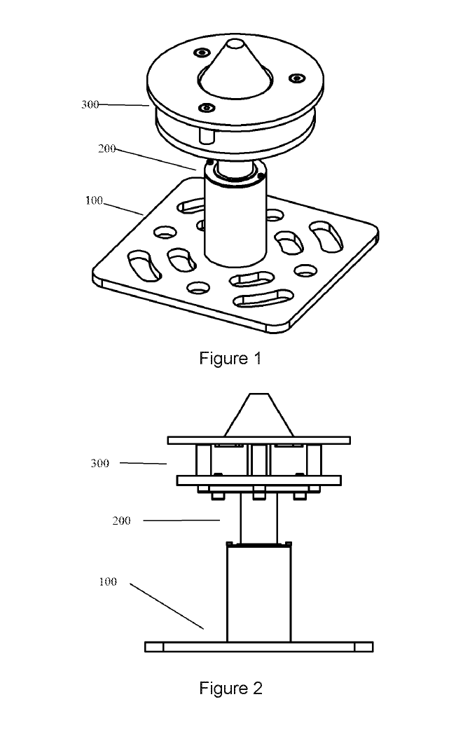

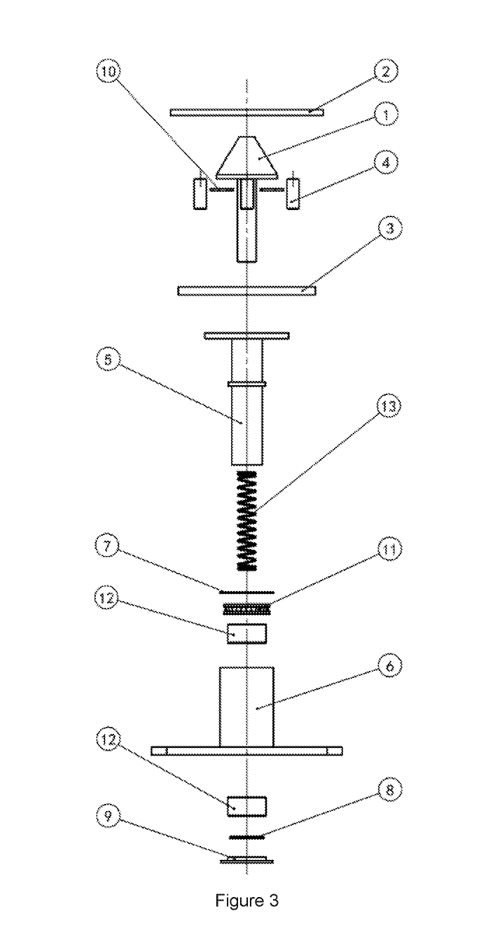

FIGS. 1-3 illustrate a device used for centering equipment having a center hole of the invention. Specifically, FIG. 1 is a stereogram of the device used for centering equipment having a center hole. FIG. 2 is a lateral sectional view of the device used for centering equipment having a center hole. FIG. 3 is an exploded view of the device used for centering equipment having a center hole.

In certain examples of the invention, the equipment having a center hole comprises a hub. In FIGS. 1-3, a deformation detection device of a hub is employed to illustrate the centering and rotary detection operations of equipment having a center hole. Optionally, the device for centering equipment having a center hole of the invention can be used for rotating or centering other equipment having a center hole, not limited to hubs.

As shown in FIGS. 1 and 2, a deformation detection device of a hub in this example comprises a base 100, a central spindle 200 partly coupled to the base 100, and an upper supporting assembly 300 partly coupled to the central spindle 200. The upper supporting assembly 300 contacts the hub, to support and center the hub. As needed, the base 100 comprises a quick connection part, which facilitates the base to fix on a worktable or a support frame. This conforms to human engineering and brings convenience for use. The base 100, the central spindle 200, and the upper supporting assembly 300 are connected and fixed with each other via connecting pieces, or are directly connected by fasteners of their own. The connection modes of the three members can be selected as needed.

With reference to accompanying FIG. 3, the deformation detection device of a hub is detailed as follows.

As shown in FIG. 3, the deformation detection device of a hub comprises: a centering head 1, a tray 2, a supporting plate 3, a support pole 4, a rotary spindle 5, a welding part 6 of a bearing seat, a dust cap 7, a spring block 8, a bearing cap 9, a limit block 10, a thrust bearing 11, a non-lubricated bearing 12, and a pressure spring 13. The components can be grouped into the base 100 (optionally comprising the bearing cap 9, the spring block 8, the non-lubricated bearing 12, and the welding part 6 of a bearing seat), the central spindle 200 (optionally comprising the non-lubricated bearing 12, thrust bearing 11, dust cap 7, pressure spring 1, and rotary spindle 5), and the upper supporting assembly 300 (optionally comprising the supporting plate 3, centering head 1, support pole 4, limit block 10, and tray 2). The upper supporting assembly 300 further comprises a bottom (may comprise, for example, the supporting plate 3) of the upper supporting assembly 300, a support structure (may comprise the tray 2, support pole 4, and limit block 10) which contacts and supports the hub, and a centering device for centering the hub (may comprise, for example, the centering head 1). It should be noted that, the components and the grouping thereof of the deformation detection device of a hub are exemplary, as needed, the deformation detection device of a hub can have more or less components. For example, in the above grouping, the centering head 1 is regarded as a member of the upper supporting assembly 300, it is known to one of ordinary in the art that, the centering head 1 can be disposed as an upper part of the central spindle 200.

In the example, the tray 2 and the supporting plate 3 are fixedly connected. The supporting plate is fixed on the support pole 4. The rotary spindle 5 is capable of rotating around the shaft. The rotation of the rotary spindle 5 around the shaft drives the supporting plate 3 to rotate, and then drives the tray 2 to rotate, thus bringing the hub on the tray 2 to rotate for detection. The arrangement is not limited to this, optionally, no supporting plate 3 is disposed, and the tray is directly fixed on the support pole to bring the hub to rotate. Actually, any arrangement, which can enable the hub to be placed on the tray and to rotate along with the tray, is practicable.

As shown in FIG. 3, the centering head 1 may comprise a bearing connected to the lower part of the centering head. The centering head 1 can be an integrated structure, or a separated structure connected using connection parts.

The centering head 1 comprises an elastic component capable of elastic contraction in the process of pressing downwards the equipment having the center hole. The elastic component is a structure adapted to elastic contraction along an axial direction. As shown in FIG. 3, the structure adapted to elastic contraction along the axial direction is a spring. Optionally, other structures can also achieve the elastic contraction along the axial direction, such as elastic sheets, air pressure elastic structure.

In use, the taper head of the centering head 1 is higher than the round disk, so when placing the hub, the central hole of the hub is aligned with the taper head of the centering head 1 and is pressed downwards. In the process, the central hole of the hub contacts the taper head, thus achieving the centering. When the central hole of the hub closely contacts the taper head, the pressure spring 13 below or other elastic devices are compressed until the mounting surface of the hub tightly contacts or is relatively parallel to the contact surface of the support structure, for example, the tray 2. As a result, the mounting surface of the hub is vertical to the axial direction, for example, to tightly contact or be relatively parallel to the tray 2 or the supporting plate 3. The shape and thickness of the tray 2 and the supporting plate 3 can be determined as needed, for example, the tray 2 and the supporting plate 3 can be a round having uniform thickness.

The central spindle 200 can be movable along the axial direction. In general, the spring or other elastic devices can uphold the central spindle. Optionally, as needed, the central spindle 200 can be fixed along the axial direction. The rotation of the central spindle 200 around the shaft can drive the upper supporting assembly 300 to rotate around the shaft, thus facilitating the operator to manually rotate the upper supporting assembly to detect the hub. Optionally, the central spindle 200 cannot rotate around the shaft, the upper supporting assembly 300 rotates around the shaft, thus facilitating the operator to manually rotate the upper supporting assembly 300 to detect the hub.

The centering head 1 of the centering device adapts to the shape and diameter of the center hole and can center the equipment having the center hole when the equipment having the center hole is being pressed downwards. The shape of the centering head 1 can be a taper, for example, a cone or pyramid, or a top-removed taper (as shown in drawings), or an umbrella-shaped, or a sector structure, and so on. Therefore, the centering head 1 can adapt to different shapes and diameters of the center hole of the hub, and maintains horizontal.

The shape of taper is adapted to hubs having different diameters of central holes. The shape of taper can reduce the friction in the process of pressing downwards, thus preventing the descending of the central spindle due to too large friction (suitable for products having different hole diameters, and the hub is easy to sleeve on the centering head). The shape of pyramid can reduce the friction in the process of pressing downwards, thus preventing the descending of the central spindle due to too large friction. In the process of pressing down the hub, the centering is completed, and the mounting surface of the hub tightly contacts the tray 2. As a result, the mounting surface of the hub is vertical to the axial direction, and is horizontal, for example, to the tray 2 or the supporting plate 3. Thereafter, rotating the hub can detect the deformation of the hub.

It should be noted that, the invention is not limited to the above disclosures, any device adapting to the shape and diameter of the center hole and can center the equipment when the equipment is being pressed downwards, falls within the protection scope of the invention. For example, the centering head 1 can be an arc, such as circular arc, including a circular arc bending inwards or a circular arc bending outwards.

In addition, except the shape options, the centering head 1 can be elastic, so as to adapt to the shape and diameter of the center hole and center the equipment having the center hole when the equipment is being pressed downwards.

Optionally, the elastic component of the centering head 1 is a structure adapted to elastic contraction inwards along a radial direction. For example, the shape of the centering head 1 is umbrella-type or sector structure, for example, the cross section thereof along the axial direction is a triangle, or a top-removed triangle. An elastic support is disposed inside, so that the angle of the support structure having the triangle cross section is variable, for example, to open and close with varying angles like an umbrella or fan. Optionally, the centering head 1 is made of rigid material or elastic material, adapt to the shape and diameter of the center hole and center the equipment having the center hole when the equipment is being pressed downwards.

In use, for the centering head 1 adapted to elastic contraction inwards along the radial direction, when placing the hub, the central hole of the hub is aligned with the umbrella or sector structure of the centering head 1 and is pressed downwards. In the pressing process, the central hole of the hub contacts the umbrella or sector structure, and presses the umbrella or sector structure to contract gradually along the radial direction, until the central hole of the hub completely contacts the tray, and the top of the centering head is clamped in the central hole of the hub, thus achieving the centering.

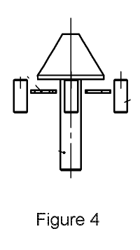

FIG. 4 is a schematic diagram of a centering device of a deformation detect device of a hub of the invention. The centering device comprises the centering head 1 and a support. The shape of the centering head 1 can be a taper, for example, a cone or pyramid, or a top-removed taper (as shown in drawings), or an umbrella-shaped, or a sector structure, and so on. Therefore, the centering head 1 can adapt to different shapes and diameters of the center hole of the hub, and maintains horizontal.

The shape of taper is adapted to hubs having different diameters of central holes. The shape of taper can reduce the friction in the process of pressing downwards, thus preventing the descending of the central spindle due to too large friction (suitable for products having different hole diameters, and the hub is easy to sleeve on the centering head). The shape of pyramid can reduce the friction in the process of pressing downwards, thus preventing the descending of the central spindle due to too large friction. In the process of pressing down the hub, the centering is completed, and the mounting surface of the hub tightly contacts the tray 2. As a result, the mounting surface of the hub is vertical to the axial direction, and is horizontal, for example, to the tray 2 or the supporting plate 3. Thereafter, rotating the hub can detect the deformation of the hub.

It should be noted that, the invention is not limited to the above disclosures, any device adapting to the shape and diameter of the center hole and can center the equipment when the equipment is being pressed downwards, falls within the protection scope of the invention. For example, the centering head 1 can be an arc, such as circular arc, including a circular arc bending inwards or a circular arc bending outwards.

In addition, except the shape options, the centering head 1 can be elastic, so as to adapt to the shape and diameter of the center hole and center the equipment having the center hole when the equipment is being pressed downwards.

Optionally, the elastic component of the centering head 1 is a structure adapted to elastic contraction inwards along a radial direction. For example, the shape of the centering head 1 is umbrella-type or sector structure, for example, the cross section thereof along the axial direction is a triangle, or a top-removed triangle. An elastic support is disposed inside, so that the angle of the support structure having the triangle cross section is variable, for example, to open and close with varying angles like an umbrella or fan. Optionally, the centering head 1 is made of elastic material, adapt to the shape and diameter of the center hole and center the equipment having the center hole when the equipment is being pressed downwards.

For example, the centering head 1 is taper-shaped in a view angle from the outside, and an elastic support is disposed inside, so that the angle of the support structure having the taper shape in a view angle from the outside is varying, like an umbrella to open and close with varying angles. Specifically, three or more support poles are employed (or, a hinge or gear is disposed on the top to achieve synchronization), with the help of a synchronization mechanism, to ensure the movement of the support poles are synchronous. In general, the opening angle of the umbrella is definite, when the hub is sleeved on the umbrella, each support pole closely contacts the central hole of the hub and contract inwards synchronously, to complete the centering. For the sector structure, two support arms and a synchronization mechanism are employed to ensure the opening angles of the two support arms are the same. In general, the opening angles of the support arms are definite, when the hub is sleeved on the sector structure, because each support arm has a certain width, each support arm has two contact points with the hub, that is, four points in total contact with the central hole of the hub, and contract inwards synchronously, to complete the centering.

Optionally, the centering head 1 is made of elastic material or elastic material, adapt to the shape and diameter of the center hole and center the equipment having the center hole when the equipment is being pressed downwards. The support includes but is not limited to a limit block, support pole. The support further comprises a tray 2.

It should be noted that, as needed, the centering device can have more or less abovementioned components. For example, the key part of the centering device is the centering head 1, that is to say, the centering device can exclude the support.

In examples of the invention, no fixtures are involved in the process of centering, thus saving the time for disassembling the hub, and no need to select the fixtures to match the hub, only to put the hub in an appropriate way to complete the centering, thus improving the efficiency. In addition, no fixtures need preparing, which greatly reduces the costs.

Specifically, the device of the invention is not limited to the detection of the deformation of a hub, it should be noted that, any device having a central hole which needs to be centered and carried out with subsequent operations through placing actions is included in the mechanism of the embodiment of the invention.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A device used for centering equipment having a center hole, the device comprising:
a base;
a central spindle, being partly coupled to the base;
an upper supporting assembly, being partly coupled to the central spindle; and
a centering device, being configured to act on the equipment having the center hole to perform centering operation.

2. The device of claim 1, wherein the equipment having the center hole includes a hub.

3. The device of claim 1, wherein the upper supporting assembly comprises a support structure which contacts and supports the equipment having the center hole, and the equipment having the center hole is axially vertical to a contact surface of the support structure.

4. The device of claim 1, wherein the centering device comprises a centering head, the centering head is disposed on the central spindle or on the upper supporting assembly; the centering head adapts to a shape and diameter of the center hole and operates to center the equipment having the center hole when the equipment having the center hole is being pressed downwards.

5. The device of claim 4, wherein the centering head comprises an elastic component capable of elastic contraction in the process of pressing downwards the equipment having the center hole.

6. The device of claim 5, wherein the elastic component is a structure adapted to elastic contraction along an axial direction.

7. The device of claim 6, wherein the structure adapted to elastic contraction along the axial direction includes a spring.

8. The device of claim 5, wherein the elastic component is a structure adapted to elastic contraction inwards along a radial direction.

9. The device of claim 4, wherein the shape of the centering head is a taper, arc, top-removed taper, and top-removed arc.

10. The device of claim 9, wherein the cone comprises a cone or pyramid, the arc comprises a circular arc, and the circular arc is bending inwards or bending outwards.

11. A centering head, adapting to a shape and diameter of a center hole of equipment and operating to act on the center hole to center the equipment having the center hole when the equipment having the center hole is being pressed downwards.

12. The centering head of claim 11, wherein the equipment having the center hole includes a hub.

13. The centering head of claim 11, wherein the centering head comprises an elastic component capable of elastic contraction in the process of pressing downwards the equipment having the center hole.

14. The centering head of claim 13, wherein the elastic component is a structure adapted to elastic contraction along an axial direction.

15. The centering head of claim 14, wherein the structure adapted to elastic contraction along the axial direction includes a spring.

16. The centering head of claim 13, wherein the elastic component is a structure adapted to elastic contraction inwards along a radial direction.

17. The centering head of claim 11, wherein the shape of the centering head is a taper, arc, top-removed taper, and top-removed arc.

18. The centering head of claim 17, wherein the cone comprises a cone or pyramid, the arc comprises a circular arc, and the circular arc is bending inwards or bending outwards.

19. A centering device, comprising a centering head of claim 11.

20. The centering device of claim 19, further comprising a support.
